(19) United States
(12) Patent Application Publication
(10) Pub. No.: US 2023/0349413 A1
(43) Pub. Date: Nov. 2, 2023

(54) Compression Limiter

(71) Applicant: Illinois Tool Works Inc., Glenview, IL (US)

(72) Inventors: Mark Beyer, Armada, MI (US); Gregory G. Buczynski, Ferndale, MI (US); Chad M. Clark, Stamping Ground, KY (US)

(21) Appl. No.: 18/137,218

(22) Filed: Apr. 20, 2023

Related U.S. Application Data
(60) Provisional application No. 63/337,359, filed on May 2, 2022.
(60) Provisional application No. 63/342,683, filed on May 17, 2022.

(51) Int. Cl. F16B 39/10; F16B 35/06

(52) U.S. Cl. CPC F16B 39/105; F16B 35/06

(57) ABSTRACT

Described is a compression-limiting fastener assembly for attaching a first component having a first opening relative to a second component having a second opening. The compression-limiting fastener assembly includes a male fastener, a retainer clip, and a female fastener. The male fastener includes a head and a shank. The retainer clip includes a recessed pocket with a fastener hole formed therein. The retainer clip includes a body portion having a pair of generally parallel legs that are resiliently connected to define a channel. The recessed pocket maintains a first distance (D₁) between the pair of generally parallel legs. The retainer clip engages the first component via the first opening and the channel. The female fastener includes a bore to receive the shank is via the fastener hole and the second opening.

### RELATED APPLICATIONS

The present application claims priority to U.S. Provisional Patent Application No. 63/337,359, filed May 2, 2022 and No. 63/342,683, filed May 17, 2022; each of which are hereby incorporated by reference in its entirety.

### BACKGROUND

Automotive components require fastening techniques that are simple to manufacture and assemble. Further, fastening techniques should above all be reliable and efficient. In some examples, it's beneficial to limit the amount of compression imparted on a component.

To that end, compression limiters can be used when an application includes a more delicate material that has a compressive load to bear. The compression limiter strengthens the assembly and accepts the load that is applied when a fastener is tightened within the assembly. When a compression limiter is used, the material's integrity is not compromised by the added pressure.

Existing compression limiters, however, are typically provided as a separate components and/or are overly complex, which increases the cost, number of components needed, and assembly complexity and time. Therefore, despite advancements to date, it would be highly desirable to have a compression limiting fastener with improved characteristics that is configured to limit the amount of compression on one or more components, such as vehicle components.

### SUMMARY

The present disclosure relates generally to a fastening system to form a connection between two components, such as vehicular components, using a compression-limiting fastener assembly, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a first isometric view of the fastening system in accordance with an aspect of this disclosure, while FIG. 1b illustrates a second isometric view of the fastening system of FIG. 1a.

FIG. 1c illustrates an elevation view of a first corner of the fastening system of FIG. 1a, while FIG. 1d illustrates an elevation view of a second corner of the fastening system of FIG. 1a.

FIG. 1e illustrates a first elevation side view of the fastening system of FIG. 1a, while FIG. 1f illustrates a cross-sectional view thereof taken along cutline A-A.

FIG. 1g illustrates a second elevation side view of the fastening system of FIG. 1a, while FIG. 1h illustrates a cross-sectional view thereof taken along cutline B-B.

FIG. 1i illustrates an isometric assembly view of the fastening system, while FIG. 1j illustrates an elevation side view thereof.

FIG. 2a illustrates a topside isometric assembly view of the compression-limiting fastener assembly of FIGS. 1a through 1j with the first and second components omitted for illustrative purposes.

FIG. 2b illustrates a side elevation assembly view of the compression-limiting fastener assembly of FIG. 2a.

FIG. 2c illustrates a side elevation cross-sectional view of the compression-limiting fastener assembly of FIG. 2a taken along cut line B-B.

FIG. 3a illustrates a side elevation assembly view of a compression-limiting fastener assembly in accordance with another aspect of this disclosure.

FIG. 3b illustrates a side elevation cross-sectional view of the compression-limiting fastener assembly of FIG. 3a taken along cut line B-B.

FIG. 4a illustrates a side elevation assembly view of a compression-limiting fastener assembly in accordance with yet another aspect of this disclosure.

FIG. 4b illustrates a side elevation cross-sectional view of the compression-limiting fastener assembly of FIG. 4a taken along cut line B-B.

FIG. 5a illustrates a side elevation assembly view of a compression-limiting fastener assembly in accordance with yet another aspect of this disclosure.

FIG. 5b illustrates a side elevation cross-sectional view of the compression-limiting fastener assembly of FIG. 5a taken along cut line B-B.

FIG. 6a illustrates a topside isometric assembly view of a compression-limiting fastener assembly configured to engage a doghouse structure in accordance with an aspect of this disclosure.

FIG. 6b illustrates an underside isometric assembly view of the compression-limiting fastener assembly of FIG. 6a.

FIG. 6c illustrates a side elevation cross-sectional view of the compression-limiting fastener assembly of FIG. 6a taken along cut line C-C.

FIG. 6d illustrates a side elevation assembly view of the compression-limiting fastener assembly of FIG. 6a.

FIG. 6e illustrates a side elevation cross-sectional view of the compression-limiting fastener assembly of FIG. 6a.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed are single-sided and double-sided compression-limiting fastener assemblies configured to limit compression imparted on one or both components, such as vehicle panels and other components thereof. As will be described, the compression-limiting fastener assemblies can be captured in an opening or doghouse of a first component and configured limit compression of the first component and/or a second component, which, in some cases, can be of varying thicknesses. The compression-limiting fastener assemblies can employ, for example, a male fastener with a head that is shaped to provide anti-rotation in an application where the fastener assembly is snapped into a component. Example fastener head shapes include, for example, a hex head, rectangular fastener head, etc.

In one example, a compression-limiting fastener assembly is used for attaching a first component having a first opening relative to a second component having a second opening. The compression-limiting fastener assembly comprises a male fastener, a retainer clip, and a female fastener. The male fastener has a head and a shank and the retainer clip has a recessed pocket with a fastener hole formed therein. The retainer clip comprises a body portion having a pair of generally parallel legs that are resiliently connected to define a channel. The recessed pocket is configured to maintain a first distance (D₁) between the pair of generally parallel legs. The retainer clip is configured to engage the first component via the first opening and the channel. The female fastener has a bore, where the shank is configured to pass through the fastener hole and the second opening to engage the bore. In some examples, the recessed pocket is formed in one of the pair of generally parallel legs and is configured to contact the other one of the pair of generally parallel legs.

In another example, a retainer clip of a compression-limiting fastener assembly for attaching a first component having a first opening relative to a second component having a second opening comprises a body portion, a recessed pocket, and a fastener hole. The body portion has a pair of generally parallel legs that are resiliently connected to define a channel, wherein the body portion is configured to engage the first component via the first opening and the channel. The recessed pocket formed in one of said pair of generally parallel legs, wherein the recessed pocket configured to maintain a first distance (D₁) between the pair of generally parallel legs. The fastener hole formed in said recessed pocket.

In another example, a compression-limiting fastener assembly is used for attaching a first component having a doghouse structure relative to a second component having an opening. The compression-limiting fastener assembly comprises a male fastener, a limiter, and a female fastener. The male fastener has a head and a shank, where the shank comprises a shoulder adjacent the head. The limiter is configured to pass at least partially into the opening and defines a through hole. The shoulder is configured to maintain a first distance (D₁) between the head and the limiter. The female fastener having a bore, wherein the shank is configured to pass through the through hole and the opening to engage the bore, wherein the limiter is configured to maintain a second distance (D₂) between the shoulder and the female fastener. In some examples, the male fastener is configured to engage the first component via the doghouse structure and the head.

In some examples, the recessed pocket is sized and shaped to receive the head of the male fastener and to mitigate rotation of the head. In some examples, the body portion defines a guide lip at an entrance to the channel. In some examples, the body portion comprises a retainer tab configured to retain the head of the male fastener within the recessed pocket prior to assembly. In some examples, the body portion comprises one or more clip tabs configured to secure the retainer clip to the first component via an interference fit. For example, each of the one or more clip tabs extends into the channel from one of the pair of generally parallel legs. In some examples, the shank comprises a shoulder adjacent the head that is configured to pass through the fastener hole and the second opening to maintain a second distance (D₂) between the body portion and the female fastener. In some examples, the retainer clip is a stamped-metal component. In some examples, the compression-limiting fastener assembly further comprises a limiter configured to pass at least partially into the second opening to maintain a second distance (D₂) between the body portion and the female fastener.

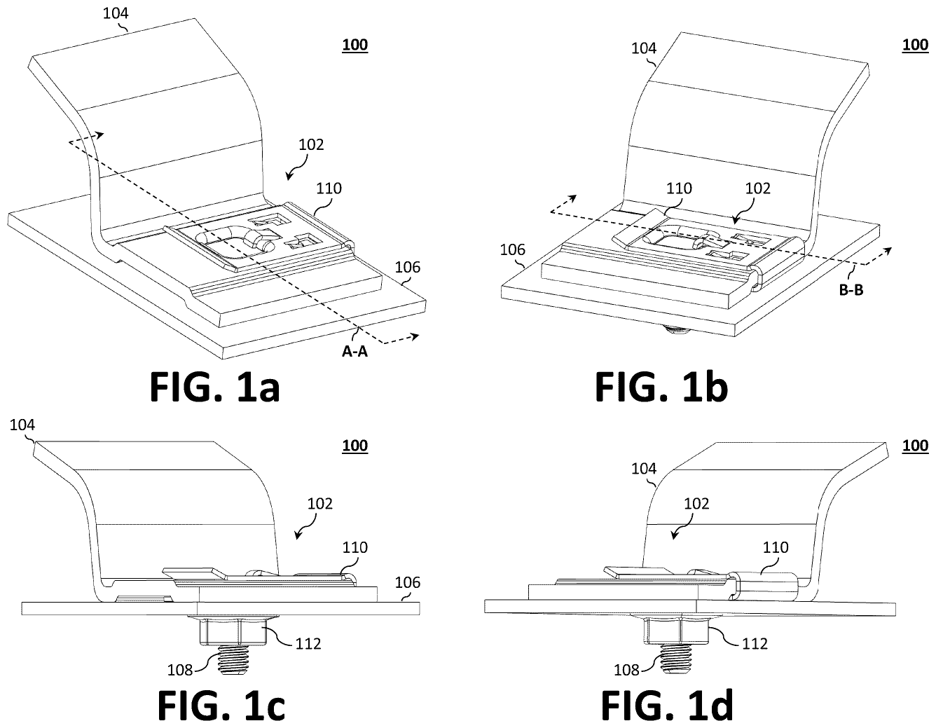

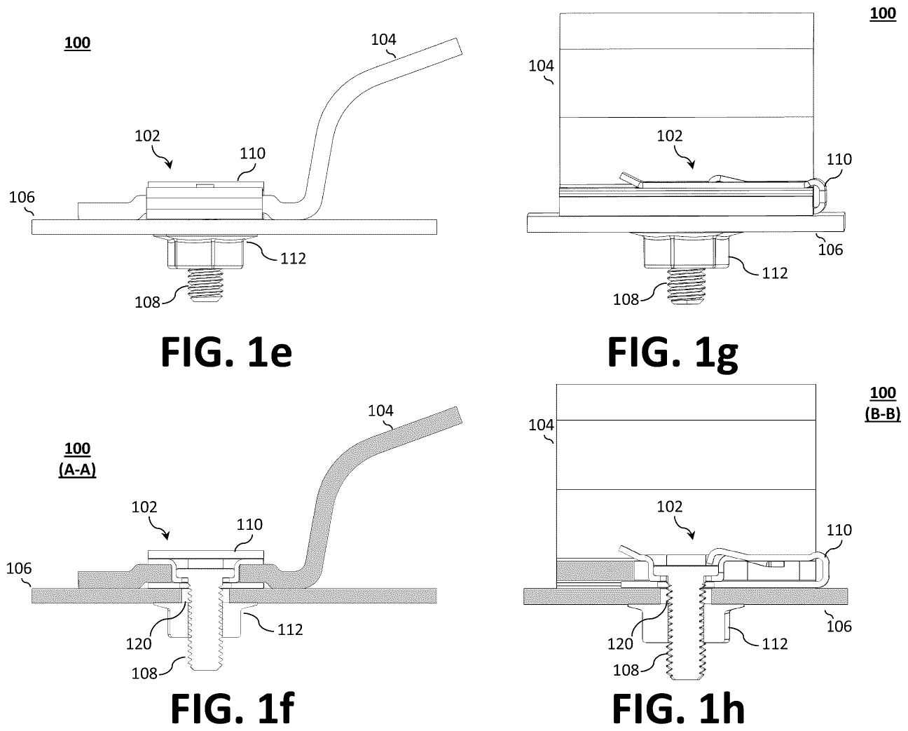

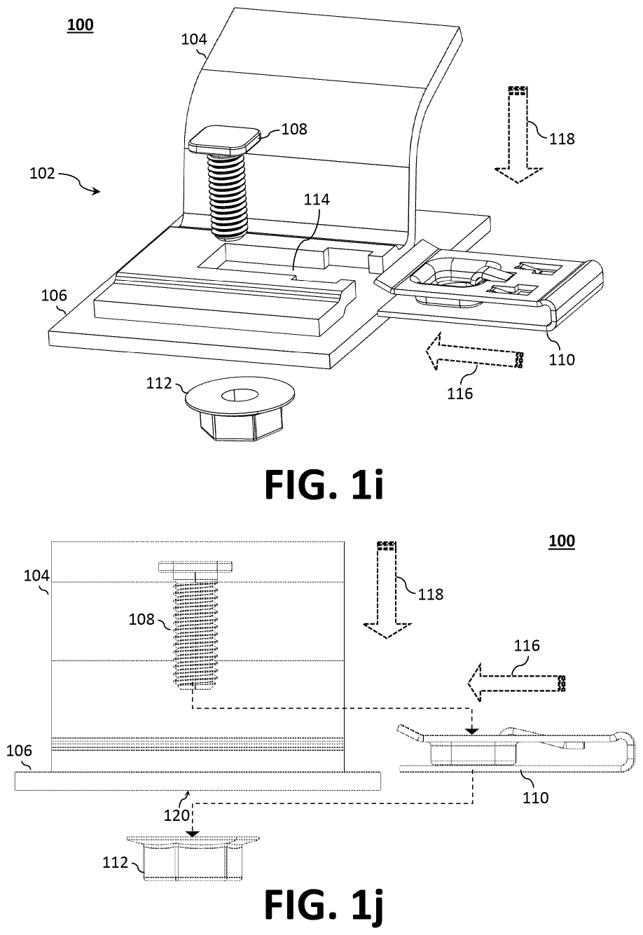

FIGS. 1a through 1j illustrate a fastening system 100 configured to couple a first component 104 relative to a second component 106 via a compression-limiting fastener assembly 102 in accordance with an aspect of this disclosure. More specifically, FIG. 1a illustrates a first isometric view of the fastening system 100 in accordance with an aspect of this disclosure, while FIG. 1b illustrates a second isometric view of the fastening system 100 of FIG. 1a. FIG. 1c illustrates an elevation view of a first corner of the fastening system 100 of FIG. 1a, while FIG. 1d illustrates an elevation view of a second corner of the fastening system 100 of FIG. 1a. FIG. 1e illustrates a first elevation side view of the fastening system 100 of FIG. 1a, while FIG. 1f illustrates a cross-sectional view thereof taken along cutline A-A. FIG. 1g illustrates a second elevation side view of the fastening system 100 of FIG. 1a, while FIG. 1h illustrates a cross-sectional view thereof taken along cutline B-B. FIG. 1i illustrates an isometric assembly view of the fastening system, while FIG. 1j illustrates an elevation side view thereof.

The illustrated fastening system 100 includes the first component 104, the second component 106, and a compression-limiting fastener assembly 102. The compression-limiting fastener assembly 102 is configured to join the first component 104 and the second component 106, while limiting compression upon the first component 104 and/or the second component 106. To facilitate attachment via the compression-limiting fastener assembly 102, each of the first component 104 and the second component 106 can include one or more engagement features. For example, the first component 104 is illustrated as having a first opening 114 formed therein and the second component 106 is illustrated as having a second opening 120 formed therein. The first opening 114 and the second opening 120 can be formed in the respective first component 104 or second component 106 during manufacturing thereof or added post-manufacture through a mechanical process (e.g., drilling, cutting, carving, etc.). After the first component 104 and the second component 106 are assembled, as best illustrated in FIGS. 1a through 1d, the second component 106 is covered at least partially by the first component 104.

The compression-limiting fastener assembly 102 is illustrated as a multi-component compression-limiting fastener assembly 102 having a male fastener 108 (e.g., an externally-threaded shaft, such as a bolt), a retainer clip 110 (e.g., a metal retainer clip), and a female fastener 112 (e.g., an internally-threaded component, such as a nut). The retainer clip 110 serves to mechanically engage and couple with the first component 104 via the first opening 114, while the male fastener 108 and the female fastener 112 serves to couple the first component (via the retainer clip 110) to the second component 106 (via its second opening 120). As illustrated, the retainer clip 110 prevents and/or mitigates compression of first component 104.

It is contemplated that certain components of the multi-component compression-limiting fastener assembly 102 may be fabricated as a stamped-metal component using a metal-stamping technique. For example, the retainer clip 110 can be fabricated from a single sheet of metal and stamped/bent using a metal-stamping technique, while the male fastener 108 and the female fastener 112 can be fabricated from metal via one or more metal-shaping techniques, such as cold forging. In another example, the retainer clip 110 can be fabricated as a stamped-metal component, whereas the male fastener 108 and the female fastener 112 can be fabricated from a plastic material using a plastic injection technique, additive manufacturing, or otherwise. In some examples, one or more components of the compression-limiting fastener assembly 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

The first component 104 and the second component 106 may be, for example, automotive panels or other automotive components. Depending on the application, one or both of the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof In the automotive industry, example first components 104 include, without limitation, door trim panels, moldings, trim pieces, and other substrates (whether used as interior or exterior surfaces). The second component 106 may be, for example, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof.

During installation, as best illustrated in FIGS. 1i and 1j, the retainer clip 110 is slid into the first opening 114 of the first component 104 as indicated by arrow 116. The first opening 114 is sized and shaped to receive and retain the retainer clip 110. In the illustrated example, the first opening 114 is generally rectangular and a portion of the first component 104 is sandwiched between the legs of the retainer clip 110 (e.g., along at least a portion of its perimeter) such that a fastener hole formed in the retainer clip 110 aligns with a second opening 120 formed in the second component 106.

Once the retainer clip 110 is installed, an end of the male fastener 108 is passed through the fastener hole formed in the retainer clip 110 and the second opening 120 as indicated by arrow 118 to ultimately engage the female fastener 112. The male fastener 108 and/or the female fastener 112 can be rotated relative to one another about its axis of rotation to join and compress the first component 104 and second component 106 relative to one another. As will be described in greater detail, the compression-limiting fastener assembly 102 includes one or more features to limit the compression imparted on the first component 104 and/or second component 106, thus mitigating risk of damaged to a component when tightening the male fastener 108 and/or the female fastener 112.

In the illustrated example, the male fastener 108 is a threaded bolt with a square head, but other types of fasteners are contemplated. In some examples, the compression-limiting fastener assembly 102 may comprise a seal when desirable to mitigate dust, dirt, and/or moisture penetration through the second opening 120. The seal may be embodied as a ring (e.g., an annulus) and fabricated from foam material, thermoplastic, rubber, etc. For example, a seal can be configured to surround a portion of the male fastener 108 (e.g., the shank) and positioned between the second component 106 and female fastener 112.

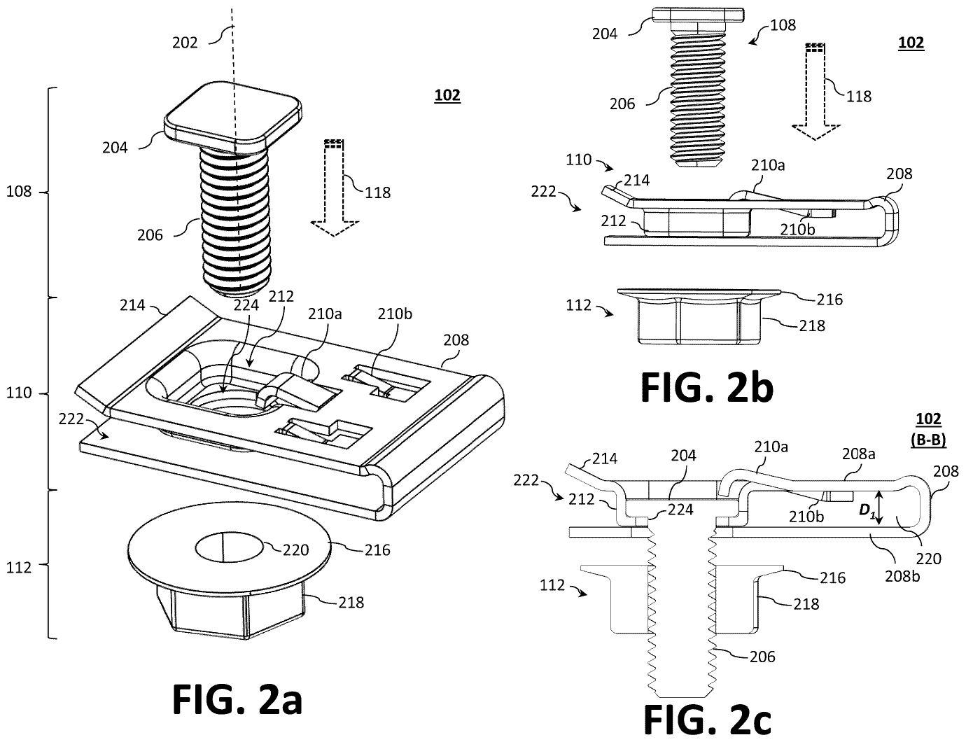

FIG. 2a illustrates a topside isometric assembly view of the compression-limiting fastener assembly 102 of FIGS. 1a through 1j with the first component 104 and second component 106 omitted for illustrative purposes. FIG. 2b illustrates a side elevation assembly view of the compression-limiting fastener assembly 102 of FIG. 2a. FIG. 2c illustrates a side elevation cross-sectional view of the compression-limiting fastener assembly 102 of FIG. 2a taken along cut line B-B. In this example, the compression-limiting fastener assembly 102 is a single-sided compression limiter, which may be used where only one of the components (e.g., the first component 104) is formed from a material that is prone to damage when compressed (e.g., plastic), while the other component (e.g., the second component 106) may be formed from a material that is less prone to damage (e.g., metal). As illustrated, the male fastener 108 comprises a head 204 and a shank 206. In the illustrated example, the head 204 is square and the shank 206 is threaded.

The illustrated retainer clip 110 comprises a body portion 208 formed with a pair of generally parallel upper and lower legs 208a, 208b that are resiliently connected at an end to form a generally U-shaped body (e.g., a spring clip) having a channel 222 (e.g., a U-shaped channel) therebetween. The pair of opposing upper and lower legs 208a, 208b are resiliently connected in that the pair of opposing upper and lower legs 208a, 208b default (e.g., spring back) to a predetermined shape. For example, as best illustrated in FIGS. 2b and 2c, the body portion 208 has a side profile that is generally U-shaped. The channel 222 is sized to slide onto and receive a least a portion of the first component 104 (e.g., the perimeter of the first opening 114). To that end, a first distance (D₁) between the pair of opposing upper and lower legs 208a, 208b generally corresponds to the thickness of the first component 104.

The illustrated upper leg 208a includes or otherwise defines a recessed pocket 212 having a fastener hole 224 therein (e.g., at a floor or base of the recessed pocket 212). The recessed pocket 212 can be shaped to correspond to the shape of the head 204. In the illustrated example, the male fastener 108 is a threaded bolt with a square head 204 and the recessed pocket 212 has a corresponding square perimeter. When assembled, the square head 204 resides within the recessed pocket 212 and is prevented from rotating about its axis of rotation 202 via the sidewalls of the recessed pocket 212. As best illustrated in FIGS. 2b and 2c, the depth of the recessed pocket 212 (e.g., the height of the sidewalls) is substantially equal to the first distance (D₁) between the pair of opposing upper and lower legs 208a, 208b such that an exterior portion of the floor of the recessed pocket 212 contacts or rests on the lower leg 208b upon assembly. The recessed pocket 212, therefore, serves as a compression limiter for the first component 104. That is, even if the male fastener 108 is overly compressed (e.g., tightened), the recessed pocket 212 maintains (or otherwise preserves) the first distance (D₁) and prevents the pair of opposing upper and lower legs 208a, 208b from compressing, which could potentially crush the portion of the first component 104 positioned within the channel 222.

The body portion 208 can further comprise a retainer tab 210a and one or more clip tabs 210b (e.g., barbs or teeth). The retainer tab 210a retains the male fastener 108 within the recessed pocket 212 prior to assembly, thus enabling the retainer clip 110 and male fastener 108 to be packaged as a part-in-assembly (PIA), thus reducing time and effort needed during assembly by an end-user. The one or more clip tabs 210b secure the retainer clip 110 to the first component 104 via an interference fit. As illustrated, each of the one or more clip tabs 210b extends into the channel 222 from one of the pair of generally parallel legs 208a, 208b. For example, the one or more clip tabs 210b can pinch, scrape, dig into, or otherwise grip the first component 104 to prevent the retainer clip 110 from sliding off. Each of the retainer tab 210a and the one or more clip tabs 210b can be stamped and/or punched from the material of the body portion 208 and bent to shape. To assist when inserting the retainer clip 110 into or onto the first opening 114, the body portion 208 can further comprise a guide lip 214 at the entrance to the channel 222. As illustrated, the guide lip 214 can be shaped at an angle to guide the first component into the channel 222.

The female fastener 112 can comprise a head 218, a flange 216, and an internally-threaded bore 220 configured to threadedly engage the shank 206. The head 218 can be hex-shaped to facilitate tool engagement, while the flange 216 serves to increase the contact surface area between the head 218 and the second component 106. As noted below, in some examples, a seal can be positioned around the shank 206 between the flange 216 and the second component 106 to form a liquid or gas barrier. FIGS. 2a through 2c illustrate the female fastener 112 in the form of a one-piece flange nut. While a one-piece female fastener 112 is illustrated, in other examples, the female fastener 112 can be a multi-component piece.

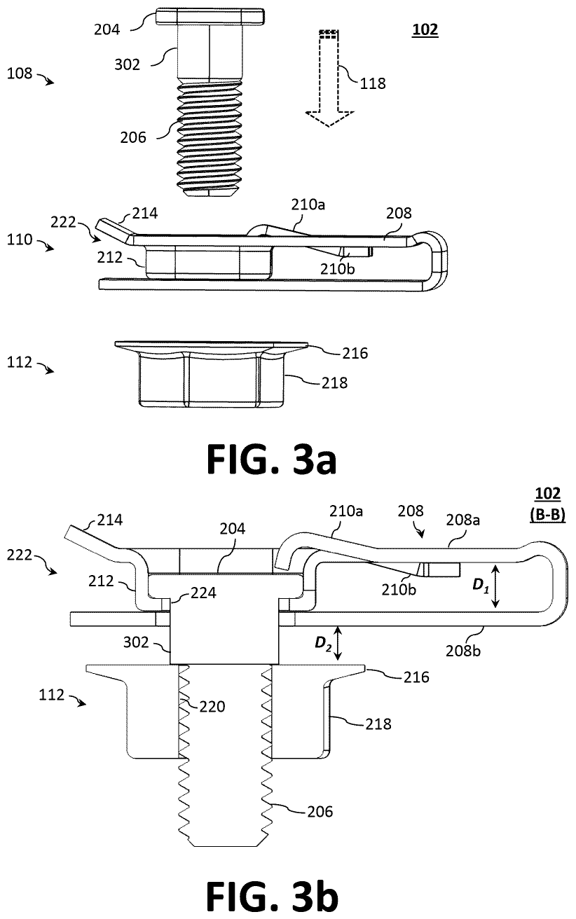

FIG. 3a illustrates a side elevation assembly view of a compression-limiting fastener assembly 102 in accordance with another aspect of this disclosure, while FIG. 3b illustrates a side elevation cross-sectional view of the compression-limiting fastener assembly 102 of FIG. 3a taken along cut line B-B. The compression-limiting fastener assembly 102 of FIGS. 3a and 3b is similar to that of FIGS. 1a through 1j and FIGS. 2a through 2c except that the compression-limiting fastener assembly 102 of FIGS. 3a and 3b is a double-sided compression limiter, which may be used where both components (e.g., the first component 104 and the second component 106) are formed from a material that is prone to damage when compressed. That is, rather than limiting compression imparted on only the first component 104, the compression-limiting fastener assembly 102 limits compression imparted on each of the first component 104 and the second component 106.

As illustrated, the male fastener 108 comprises a head 204 and a shank 206 with a shoulder 302 adjacent the head 204. For example, a shoulder bolt. An advantage of using a shoulder bolt is that shoulder 302 eliminates a need for a separate limiter component in the compression-limiting fastener assembly 102. In the illustrated example, the head 204 is square and the portion of the shank 206 beyond the shoulder is threaded. When assembled, the shank 206 (and the shoulder 302) pass at least partially through the fastener hole 224 and the second opening 120. As best illustrated in FIG. 3b, the shoulder 302 limits compression imparted on the second component 106 via the female fastener 112. More specifically, the diameter of the shoulder 302 is greater than the diameter of the threaded bore 220 (and the shank 206) such that the female fastener 112 is prevented from further compressing upon contact with the shoulder 302, thus maintaining a second distance (D₂) between the lower leg 208b of the body portion 208 and the female fastener 112. The second distance (D₂) between the lower leg 208b of the body portion 208 and the female fastener 112 generally corresponds to the thickness of the second component 106. Therefore, the recessed pocket 212 maintains the first distance (D₁) for the first component, while the shoulder 302 maintains the second distance (D₂) for the second component.

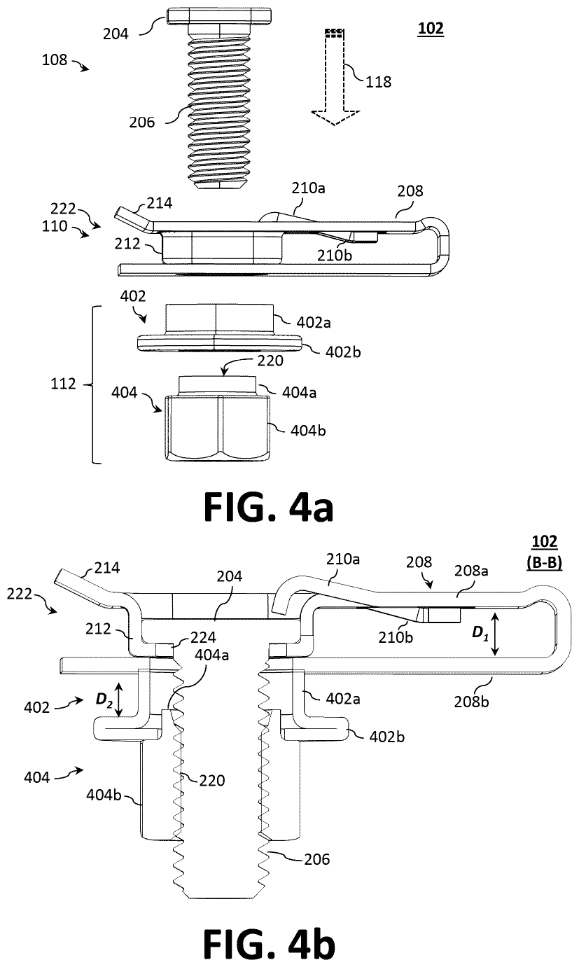

FIG. 4a illustrates a side elevation assembly view of a compression-limiting fastener assembly 102 in accordance with yet another aspect of this disclosure, while FIG. 4b illustrates a side elevation cross-sectional view of the compression-limiting fastener assembly 102 of FIG. 4a taken along cut line B-B. The compression-limiting fastener assembly 102 of FIGS. 4a and 4b is similar to that of FIGS. 1a through 1j and FIGS. 2a through 2c except that the compression-limiting fastener assembly 102 of FIGS. 4a and 4b is a double-sided compression limiter. As illustrated, the female fastener 112 is a two-piece component having a limiter 402 and a threaded component 404 that defines the internally-threaded bore 220.

The limiter 402 comprises a limiter sidewall 402a and a flange 402b. As best illustrated in FIG. 4b, the diameter of the limiter sidewall 402a, which is illustrated as generally cylindrical, is larger than the dimeter of the fastener hole 224, but smaller than the second opening 120. The limiter 402 is sized and shaped such that the height of the limiter sidewall 402a is substantially equal to the thickness of the second component 106. As illustrated, the second distance (D₂) between the lower leg 208b of the body portion 208 and the interior surface of the flange 402b generally corresponds to the thickness of the second component 106. Thus, the limiter 402 is configured to pass at least partially into the second opening 120 to maintain the second distance (D₂) between the body portion 208 and the female fastener 112. In the illustrated example, the threaded component 404 comprises a lip portion 404a and a head portion 404b. When assembled, the lip portion 404a resides within the flange 402b of the limiter 402, thus keeping them coupled together and coaxially aligned.

As best illustrated in FIG. 4b, the limiter 402 limits compression imparted on the second component 106 via the female fastener 112. More specifically, the diameter of the limiter 402 is greater than the diameter of the fastener hole 224 such that the threaded component 404 is prevented from making contact with the retainer clip 110, thus maintaining the second distance (D₂), which generally corresponds to the thickness of the second component 106.

In the illustrated example, the female fastener 112 is provided in the form of a SEM (i.e., a pre-asSEMbled) nut fastener, where the limiter 402 is permanently attached to the threaded component 404. A SEM fastener can ensure faster product assembly, decrease failures relating to improper mounting, facilitate quick product assembly in the case of small dimensions, make service and repair in rough surroundings or hard-to-reach areas easier and safer, facilitate inventory and logistics by requiring fewer item numbers, and make disassembly faster and easier. While the illustrated female fastener 112 is provided in the form of a SEM nut fastener, other configurations are contemplated, such as a limiter 402 that is not permanently attached to a threaded component 404.

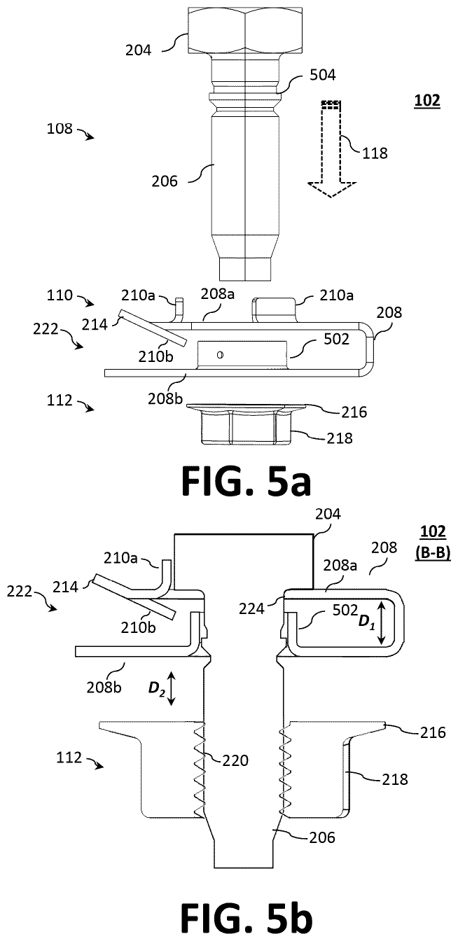

While the preceding examples illustrate a male fastener 108 with a head 204 that is recessed into recessed pocket 212, other configurations are possible. FIG. 5a illustrates a side elevation assembly view of a compression-limiting fastener assembly 102 in accordance with yet another aspect of this disclosure, while FIG. 5b illustrates a side elevation cross-sectional view of the compression-limiting fastener assembly 102 of FIG. 5a taken along cut line B-B. In this example, the head 204 of the male fastener 108 is located at the surface of the upper leg 208a and fixed in place via a plurality of retainer tabs 210a.

The central sleeve 502 of the retainer clip 110 extends into the channel 222 from one of the pair of generally parallel legs 208a, 208b (illustrated as extending from the lower leg 208b) and serves a function similar to that of the recessed pocket 212 by preventing the upper and lower legs 208a, 208b of the retainer clip 110 from coming too close to each other during nut assembly. That is, it maintains the first distance (D₁). The height of the central sleeve 502 can be adjusted (i.e., increased or decreased) to maintain a desired first distance (D₁). In this example, as best illustrated in FIG. 5b, one or more retainer tabs 210a (illustrated as flanges) are positioned and angled at about 90 degrees relative to the surface of the upper leg 208a and in intimate contact with one or more sides of the head 204 to prevent rotation of the male fastener 108 when assembled. The male fastener 108 can further comprise one or more retention features 504 (e.g., a ledge, ridge, etc.) on the shank 206 to prevent the male fastener 108 from separating vertically from the retainer clip 110 (e.g., from exiting the fastener hole 224). In use, the retainer clip 110 and male fastener 108 may be packaged as a PIA, thus reducing time and effort needed during assembly by an end-user.

While the preceding example describe a compression-limiting fastener assembly 102 configured to engage a first opening 114 in the first component 104 via a retainer clip 110, other configurations are contemplated, such as using a doghouse structure on the first component 104.

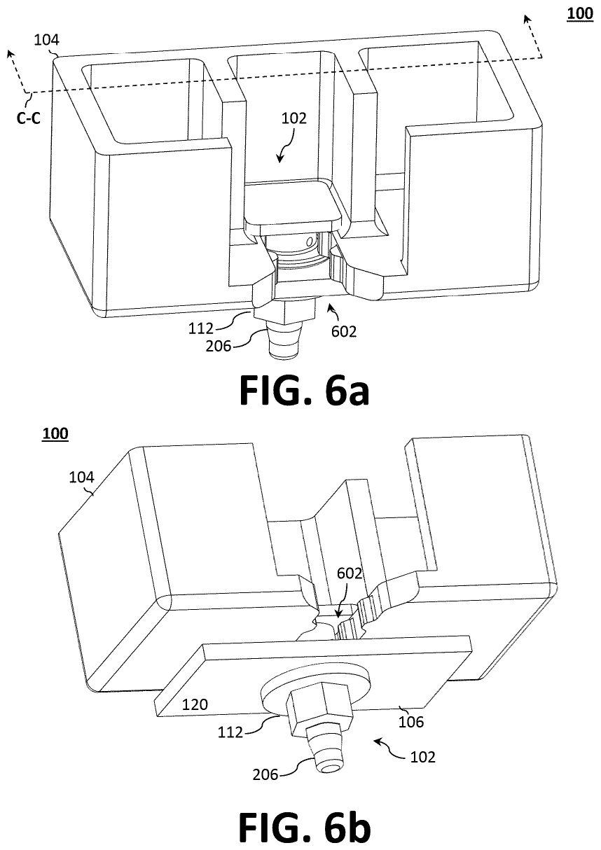

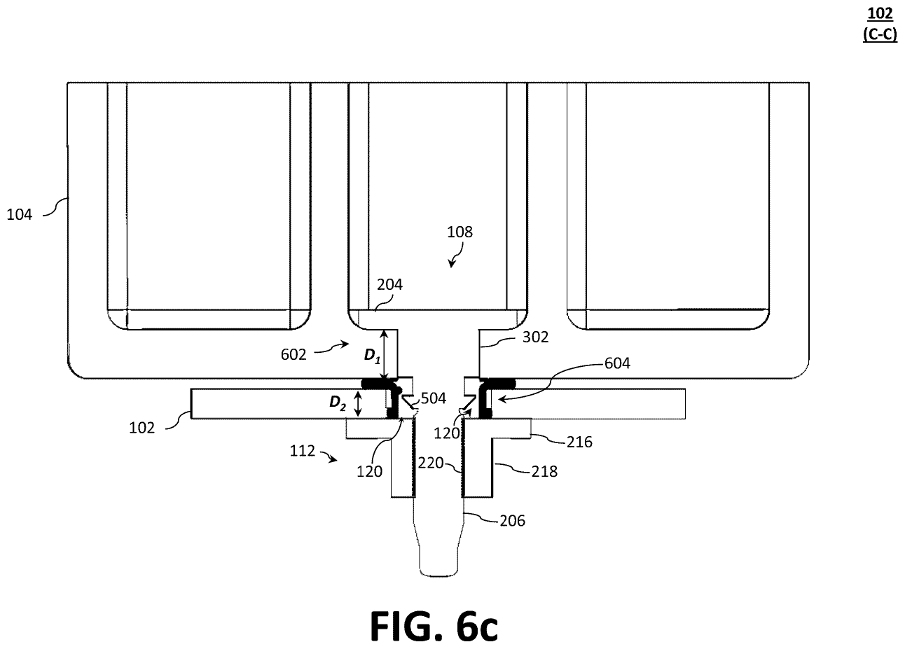

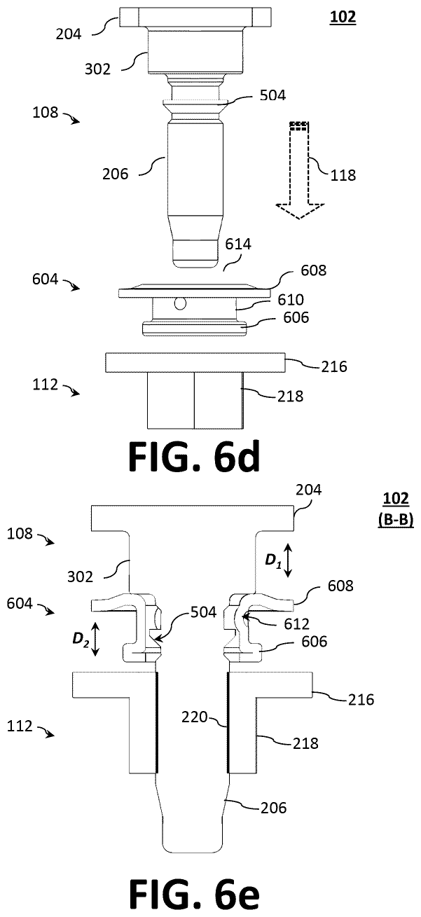

FIG. 6a illustrates a topside isometric assembly view of a compression-limiting fastener assembly 102 configured to engage a doghouse structure 602 in accordance with an aspect of this disclosure, while FIG. 6b illustrates an underside isometric assembly view of the compression-limiting fastener assembly 102 of FIG. 6a. FIG. 6c illustrates a side elevation cross-sectional view of the compression-limiting fastener assembly 102 taken along cut line C-C. FIGS. 6e and 6e illustrate, respectively, a side elevation assembly and assembled views of the compression-limiting fastener assembly 102 of FIG. 6a.

The compression-limiting fastener assembly 102 comprises a male fastener 108, a limiter 604, and a female component 112, that defines the internally-threaded bore 220. The head 204 can be a standard hex head or a rectangular head to provide anti-rotation, for example, in the illustrated application where the compression-limiting fastener assembly 102 is snapped into a first component 104. The compression-limiting fastener assembly 102 of FIGS. 6a through 6e is similar to that of FIGS. 4a and 4b except that the compression-limiting fastener assembly 102 of FIGS. 6a through 6e is a double-sided compression limiter configured to engage the first component 104 via a doghouse structure 602 rather than via a retainer clip 110 and a first opening 114. Therefore, in this example, the first component 104 may include or define, the doghouse structure 602. A doghouse structure 602 allows for the first component 104 to be used with a wide variety of fasteners, including the compression-limiting fastener assembly 102.

As best illustrated in FIGS. 6a through 6c, the male fastener 108 defines a head 204 and a shank 206 having a shoulder 302 configured to slide into the doghouse structure 602. As illustrated, the male fastener 108 includes a head 204 that is rectangular and snapped into the first component 104 via a doghouse structure 602 to provide compression limiting to the first component 104. A head 204 that is rectangular-shaped prevents rotation thereof, essentially fixing the male fastener 108 in place. A second component 106 is inserted over the shank 208, which provides compression limiting via the limiter 604. Lastly, a rotating female fastener 112 is used to tighten the compression-limiting fastener assembly 102. The limiter 604 can be inserted into the second opening 120 of the second component 106. For example, the second component 106 can reside between a first flange 606 and a second flange 608 that are separated by a limiter sidewall 610, which is illustrated as generally cylindrical. As illustrated, the second distance (D₂) between the first flange 606 and the second flange 608 generally corresponds to the thickness of the second component 106. The first flange 606 and the second flange 608 serve to increase contact area.

As best illustrated in FIG. 6e, the male fastener 108 can further comprise one or more retention features 504 on the shank 206 to prevent the male fastener 108 from separating vertically from the limiter 604. The limiter 604 can likewise include one or more retention features 612 (e.g., one or more bumps or protrusions, an annular ridge, etc.) on an inner surface of the limiter 604 to engage the one or more retention features 504 on the shank 206. As illustrated, the limiter 604 defines a through hole 614 and is configured to pass at least partially into the opening 120. The shank 206 is configured to pass through the through hole 614 and the opening 120 to engage the bore 220. In this example, the shoulder 302 is configured to maintain the first distance (D₁) between the head 204 and the limiter 604, and the limiter 604 is configured to maintain the second distance (D₂) between the shoulder 302 and the female fastener 112.

While illustrated with a doghouse structure 602, in other examples, the compression-limiting fastener assembly 102 can be pre-captured into a first component 104 via a first opening to provided compression limiting to the first component 104 via the shoulder 302 and then inserted into the second opening 120 of the second component 106 to provide compression limiting to that second component 106 via a limiter 604. In this example, the male fastener 108 can be tightened via rotation to tighten the assembly into an internally-threaded hole (e.g., of a female fastener 112). In another example, a nut with captured compression limiter can be used for the second component 106 (e.g., a SEM component as described and illustrated in connection with FIGS. 4a and 4b). As noted above, capturing the fastener components mitigates the risk of fasteners or limiters from falling out in transit in addition to saving assembly time.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A compression-limiting fastener assembly for attaching a first component having a first opening relative to a second component having a second opening, the compression-limiting fastener assembly comprising:
a male fastener having a head and a shank;
a retainer clip having a recessed pocket with a fastener hole formed therein,
wherein the retainer clip comprises a body portion having a pair of generally parallel legs that are resiliently connected to define a channel,
wherein the recessed pocket is configured to maintain a first distance (D₁) between the pair of generally parallel legs, and
wherein the retainer clip is configured to engage the first component via the first opening and the channel; and
a female fastener having a bore, wherein the shank is configured to pass through the fastener hole and the second opening to engage the bore.

2. The compression-limiting fastener assembly of claim 1, wherein the recessed pocket is formed in one of the pair of generally parallel legs and is configured to contact the other one of the pair of generally parallel legs.

3. The compression-limiting fastener assembly of claim 1, wherein the recessed pocket is sized and shaped to receive the head of the male fastener and to mitigate rotation of the head.

4. The compression-limiting fastener assembly of claim 1, wherein the body portion defines a guide lip at an entrance to the channel.

5. The compression-limiting fastener assembly of claim 1, wherein the body portion comprises a retainer tab configured to retain the head of the male fastener within the recessed pocket prior to assembly.

6. The compression-limiting fastener assembly of claim 1, wherein the body portion comprises one or more clip tabs configured to secure the retainer clip to the first component via an interference fit.

7. The compression-limiting fastener assembly of claim 6, wherein each of the one or more clip tabs extends into the channel from one of the pair of generally parallel legs.

8. The compression-limiting fastener assembly of claim 1, wherein the shank comprises a shoulder adjacent the head that is configured to pass through the fastener hole and the second opening to maintain a second distance (D₂) between the body portion and the female fastener.

9. The compression-limiting fastener assembly of claim 1, wherein the retainer clip is a stamped-metal component.

10. The compression-limiting fastener assembly of claim 1, further comprising a limiter configured to pass at least partially into the second opening to maintain a second distance (D₂) between the body portion and the female fastener.

11. A retainer clip of a compression-limiting fastener assembly for attaching a first component having a first opening relative to a second component having a second opening, the retainer clip comprising:
a body portion having a pair of generally parallel legs that are resiliently connected to define a channel, wherein the body portion is configured to engage the first component via the first opening and the channel;
a recessed pocket formed in one of said pair of generally parallel legs, wherein the recessed pocket configured to maintain a first distance (D₁) between the pair of generally parallel legs; and
a fastener hole formed in said recessed pocket.

12. The retainer clip of claim 11, wherein the recessed pocket is configured to contact the other one of the pair of generally parallel legs.

13. The retainer clip of claim 11, wherein the recessed pocket is sized and shaped to receive a head of a male fastener and to mitigate rotation of the head.

14. The retainer clip of claim 11, wherein the body portion defines a guide lip at an entrance to the channel.

15. The retainer clip of claim 13, wherein the body portion comprises a retainer tab configured to retain the head of the male fastener within the recessed pocket prior to assembly.

16. The retainer clip of claim 11, wherein the body portion comprises one or more clip tabs configured to secure the retainer clip to the first component via an interference fit.

17. The compression-limiting fastener assembly of claim 16, wherein each of the one or more clip tabs extends into the channel from one of the pair of generally parallel legs.

18. The retainer clip of claim 11, wherein the body portion is a stamped-metal component.

19. A compression-limiting fastener assembly for attaching a first component having a doghouse structure relative to a second component having an opening, the compression-limiting fastener assembly comprising:
a male fastener having a head and a shank, wherein the shank comprises a shoulder adjacent the head;
a limiter configured to pass at least partially into the opening and defines a through hole,
wherein the shoulder is configured to maintain a first distance (D₁) between the head and the limiter; and
a female fastener having a bore, wherein the shank is configured to pass through the through hole and the opening to engage the bore, wherein the limiter is configured to maintain a second distance (D₂) between the shoulder and the female fastener.

20. The compression-limiting fastener assembly of claim 19, wherein the male fastener is configured to engage the first component via the doghouse structure and the head.
